(19) United States
(12) Patent Application Publication
(10) Pub. No.: US 2014/0184033 A1
(43) Pub. Date: Jul. 3, 2014

(54) DC MOTOR MODULE AND POWER DRIVING DEVICE THEREOF

(71) Applicant: Mobiletron electronics Co., Ltd., Taichung City (TW)

(72) Inventor: Chen-Ku WEI, Nantou County (TW)

(73) Assignee: Mobiletron Electronics Co., Ltd., Taichung City (TW)

(21) Appl. No.: 14/135,075

(22) Filed: Dec. 19, 2013

(30) Foreign Application Priority Data
Dec. 28, 2012 (CN) 201210586787.5

(51) Int. Cl. H02P 29/00; H02M 3/155

(52) U.S. Cl. CPC H02P 29/00; H02M 3/155
USPC 310/68 D; 323/311

(57) ABSTRACT

A power driving device includes six semiconductor switches and three reverse breakdown diodes. The semiconductor switches has a first end and a second end respectively, and the semiconductor switches are three upper arm semiconductor switches and three lower arm semiconductor switches, wherein end first ends of the upper arm semiconductor switches are electrically connected together, and the second ends electrically connected to each coil of a three-phase coil assembly; the second ends of the lower arm semiconductor switches electrically connected together, and the first ends electrically connected to the second ends of the upper arm semiconductor switches respectively; each diode has an anode and a cathode, wherein the anodes are electrically connected to the second ends of the upper semiconductor switches respectively, and the cathodes are electrically connected to the first ends of the upper arm semiconductor switches respectively.

The current application claims a foreign priority to the patent application of China No. 201210586787.5 filed on Dec. 28, 2012.

### BACKGROUND OF THE INVENTION

1. Technical Field

The present invention relates generally to a motor, and more particular to a DC (direct current) motor and a power driving device thereof.

2. Description of Related Art

Typically, a conventional brushless DC motor has a three-phase coil, a power driving device, and a control circuit. The conventional power driving device has six MOSFETs to be six electric switches. The control circuit turns on or off the electric switches respectively to control the three-phase coil. As a result, the brushless DC motor will work efficiently.

However, when the motor is working in low voltage (with the same power), there will be large currents in each phase of the coil, so that the electric switches have to work in a high current environment to avoid from burning. In addition, because the electric switches are turned on and off quickly, the coil is loaded with high-voltage surge because of back EMF, and usually this high-voltage surge is several times greater than the working voltage. The high-voltage surge is higher with heavier loading. Therefore, the electric switches must have the ability to withstand high current and high voltage.

For a brushless DC motor with a power less than 500W, the power driving device usually has to withstand voltage higher than 70V and current around 30A in a long time. However, the conventional MOSFET with such capacity is very expensive and huge. Furthermore, the heat generated in the MOSFETs is another problem. It has to provide heat sink to make sure that the MOSFETs may work.

Normally, it is unfavorable to the minimization of dimension of the brushless DC motor. In conclusion, the conventional brushless DC motor still has to be improved.

### BRIEF SUMMARY OF THE INVENTION

In view of the above, the primary objective of the present invention is to provide a DC motor and a power driving device, which has a small dimension, high efficiency of heat dissipation, and low cost.

The present invention provides a DC motor, which includes a case, a three-phase coil assembly, a power driving device, and a controller; wherein the three-phase coil assembly has three coils, and is received in the case; the power driving device is received in the case, and includes three upper arm semiconductor switches, three lower are semiconductor switches, and three reverse breakdown diodes, wherein each of the three upper arm semiconductor switches has a first end and a second end, wherein the first ends of the upper arm semiconductor switches are electrically connected together, and the second ends thereof are electrically connected to the three coils of the three-phase coil assembly respectively; each of the three lower arm semiconductor switches has a first end and a second end, wherein the second ends of the lower arm semiconductor switches are electrically connected together, and the first ends thereof are electrically connected to the second ends of the upper arm semiconductor switches respectively; each of the three reverse breakdown diodes has an anode and a cathode, wherein the anodes of the reverse breakdown diodes are electrically connected to the second ends of the upper arm semiconductor switches respectively, and the cathodes thereof electrically connected to the first ends of the upper arm semiconductor switches respectively; the controller electrically connected to the upper arm semiconductor switches and the lower are semiconductor switches respectively to turn on and off the upper arm semiconductor switches and the lower arm semiconductor switches.

In an embodiment, the power driving device further includes three reverse breakdown diodes, each of which has an anode and a cathode; the anodes of the reverse breakdown diodes are electrically connected to the second ends of the lower arm semiconductor switches respectively, and the cathodes thereof electrically connected to the first ends of the lower arm semiconductor switches respectively.

With such design, the aforementioned reverse breakdown diodes provide protection to allow the DC motor to use cheaper and smaller semiconductor switches which withstand lower voltage. Therefore, the DC motor may have a small dimension, high efficiency of heat dissipation, and low cost.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first preferred embodiment of the present invention;

FIG. 2 is a partial sectional view of the preferred embodiment of the present invention;

FIG. 3 is a block diagram of the circuit of the preferred embodiment of the present invention; and

FIG. 4 is a circuit of the power driving device of the preferred embodiment of the present invention.

### DETAILED DESCRIPTION OF THE INVENTION

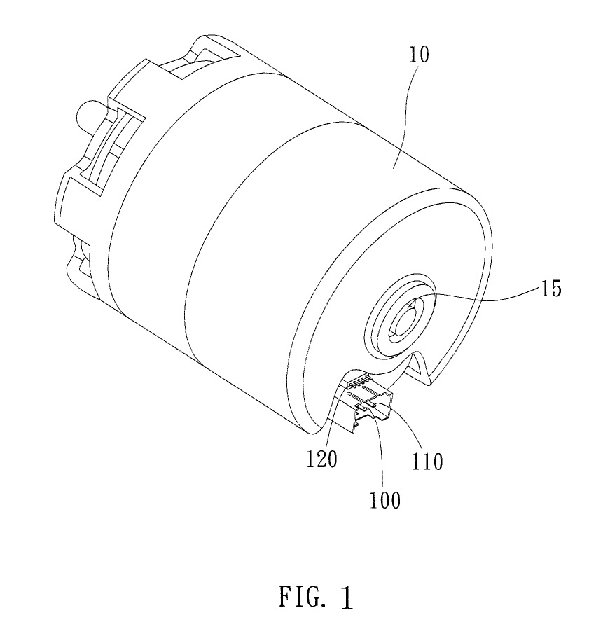

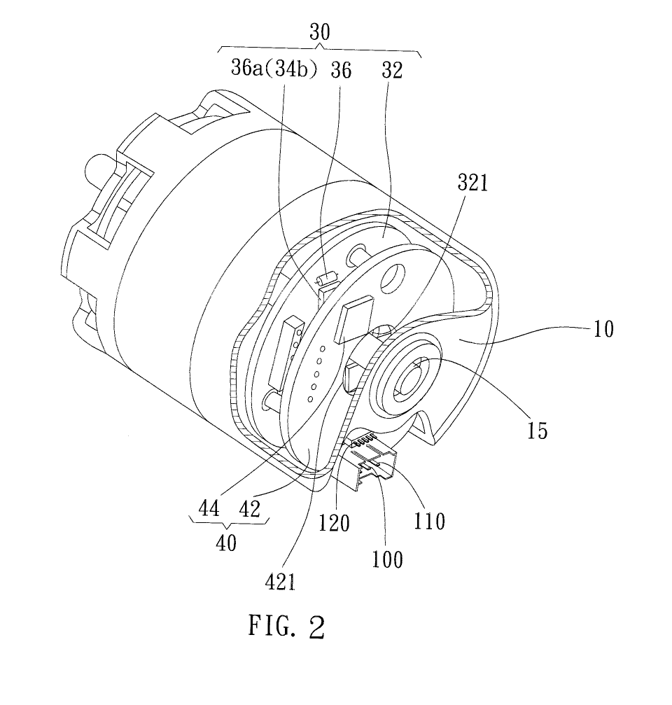

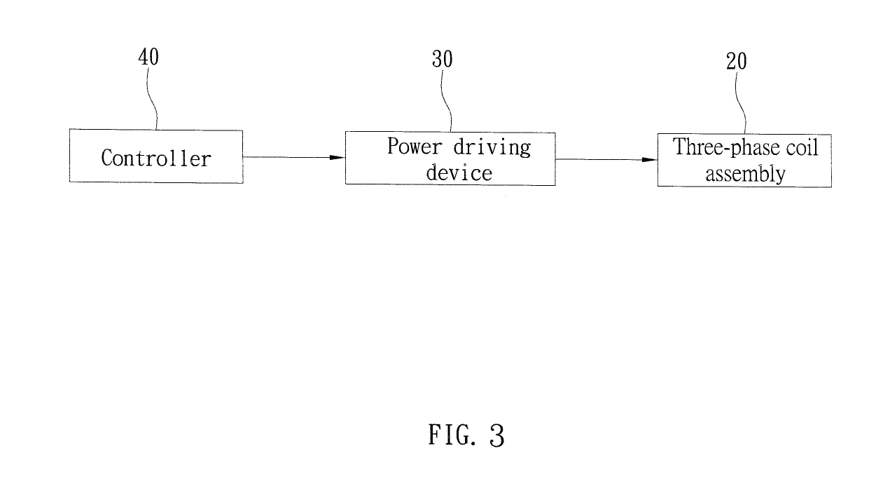

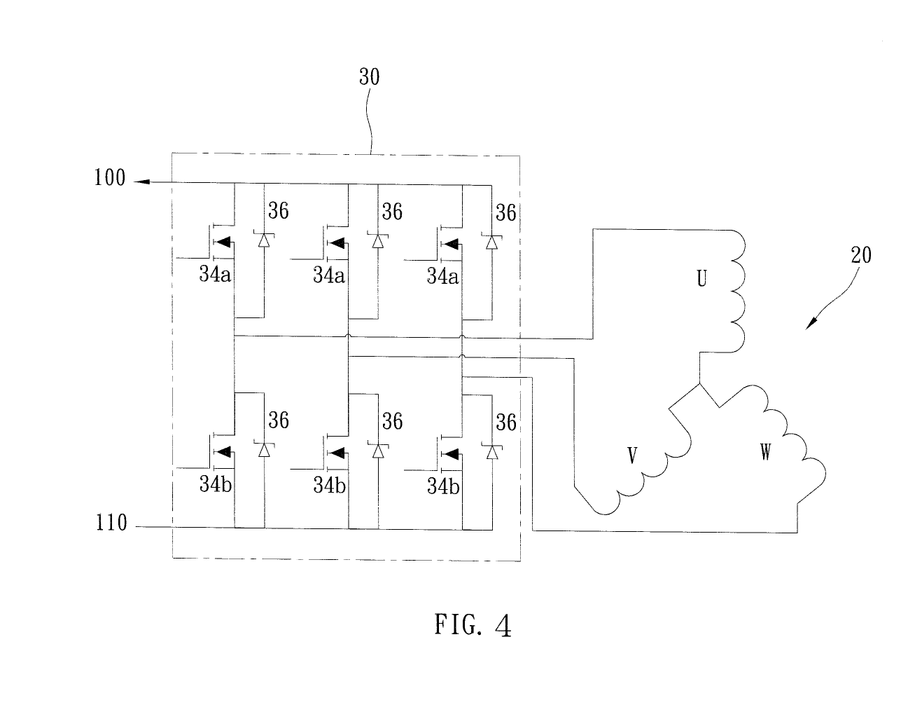

As shown in FIG. 1 to FIG. 4, a brushless DC motor of the preferred embodiment of the present invention includes a case 10, a shaft 15 in the case 10, a three-phase coil assembly 20, a power driving device 30, and a controller 40. There still are some elements in the brushless DC motor but not described, and these elements are not the main features of the present invention and they are known by a person skilled in the art of DC motor, so we do not describe them here.

The shaft 15 has at least one end extending out of the case 10. The three-phase coil assembly 20 has a first phase coil U, a second phase coil V, and a third phase coil W to turn the shaft 15 by electromagnetic force. The shaft 15 and the three-phase coil assembly 20 are an inner rotor of the DC motor, and of course, they can be designed as an outer rotor.

The power driving device 30 is the main feature of the present invention. The power driving device 30, which is electrically connected to the three-phase coil assembly 20, has a first substrate 32, six semiconductor switches 34a, 34b, and six reverse breakdown diodes 36. The first substrate 32 is provided in the case, and has a circuit layout (not shown) thereon and a bore 321 at a center thereof for the shaft 15 passing through and rotating freely. The semiconductor switches 34a, 34b are mounted on the first substrate 32 and electrically connected to the conductor pattern. In an embodiment, each semiconductor switch 34a, 34b is a single MOSFET (metal-oxide-semiconductor field-effect transistor) to turn on or turn off a current. In another embodiment, each semiconductor switch 34a, 34b has a plurality of MOSFETs in parallel. Each semiconductor switch 34a, 34b has a first end (the drain of the MOSFET) and a second end (the source of the MOSFET). The semiconductor switches 34a, 34b are three upper arm semiconductor switches 34a and three lower arm semiconductor switches 34b. The first ends of the upper arm semiconductor switches 34a are electrically connected together and are connected to a power circuit 100, which extends out of the case 10. The second ends of the upper arm semiconductor switches 34a are electrically connected to the first phase coil U, the second phase coil V, and the third phase coil W of the three-phase coil assembly 20 respectively.

The second ends of the lower arm semiconductor switches 34b are electrically connected together and are connected to a ground circuit 110, which extends out of the case 10. The first ends of the lower arm semiconductor switches 34b are electrically connected to the second ends of the upper arm semiconductor switches 34a respectively. As a result, while the power circuit 100 and the ground circuit 110 are connected to a power source, it may select which coil U, V, W to be connected to the power circuit 100 and the ground circuit 110 by specific combinations of switching on or off the semiconductor switches 34a, 34b. The reverse breakdown diodes 36 are mounted on the first substrate 32. In an embodiment, the reverse breakdown diodes 36 are avalanche diodes, each of which has an anode and a cathode. Three of the avalanche diodes 36 have the anodes electrically connected to the second ends of the upper arm semiconductor switches 34a respectively, and have the cathodes electrically connected to the first ends of the upper arm semiconductor switches 34a respectively. The other three of the avalanche diodes 36 have the anodes electrically connected to the second ends of the lower arm semiconductor switches 34b respectively, and have the cathodes electrically connected to the first ends of the lower arm semiconductor switches 34b respectively.

Therefore, the avalanche diodes 36 will have reverse breakdown when the three-phase coil assembly 20 generates high voltage surge, and the reverse breakdown voltage will be about 24V-28V. The energy of the surge will be absorbed by the avalanche diodes 36 and converted into heat. As a result, the voltage difference between the first end and the second end of each semiconductor switch 34a, 34b will be lower than the reverse breakdown voltage. With the arrangement of the semiconductor switches 34a, 34b and the reverse breakdown diodes 36 in parallel, the semiconductor switches 34a, 34b may choose the MOSFET which withstand lower voltage (slightly higher than the working voltage and reverse breakdown voltage). For example, if the DC motor is applied in 20V and maximum 300W, it may choose the MOSFETs with Rds-on (Drain—source ON resistance) less than 1.59 m Ω, dimension is 5×6 mm², and voltage withstanding of 30V. Such MOSFETs of low Rds-on may be directly attached to the first substrate 32 without having to worry about the heat problem. A copper foil on the substrate is enough for heat dissipation, so that the DC motor may be not equipped with a fan or a heat sink. With the arrangement of the semiconductor switches 34a, 34b and the reverse breakdown diodes 36 in parallel, in comparison with the conventional MOSFET with voltage withstanding higher than 70V, the present invention has a low cost and small dimension.

The controller 40 is electrically connected to the power driving device 30, and it further has a second substrate 42 and a control unit 44. The second substrate 42 has a specific conductor pattern (not shown) thereon, and the conductor pattern is electrically connected to the conductor pattern of the first substrate 42. The second substrate 42 has a bore 421 at center thereof as well for the shaft 15 passing through, so that the shaft 15 rotates freely. The control unit 44 is mounted on the second substrate 42, and is electrically connected to the semiconductor switches 34a, 34b. The second substrate 42 further is provided with a Hall Effect sensor (not shown) on a side opposite to a side with the control unit 44. The control unit 44 may turn on and off the semiconductor switches 34a, 34b according to the detecting result of the Hall effect sensor to control the DC motor. In practices, it may provide a control circuit 120 connected to the controller 40, and the control circuit 120 extends out of the case 10 and connects to an outer controller (not shown) to control the controller 40 so as to turn on and off the semiconductor switches 34a, 34b by the outer controller.

With the design of the present invention, it may protect the semiconductor switches 34a, 34b from being burned out, and the dimension may be reduced to mount the power driving device 30 and the controller 40 in the case 10, so that the DC motor would have no drawback of the prior art.

It is noted that except for avalanche diodes, zener diodes and transient voltage suppressor (TVS) also may be selected to be the reverse breakdown diodes 36. In an embodiment, there could be only three reverse breakdown diodes 36 connected to the upper arm semiconductor switches 34a respectively instead.

The DC motor of the present invention may be provide with a heat sink if the DC motor is designed to work in higher current (80A for example). However, the reverse breakdown diodes 36 still may reduce the surge, so that the heat of the semiconductor switches 34a, 34b still are lower than the conventional device, and therefore the DC motor of the present invention will have a low cost and small dimension compared with the conventional device.

Except for the brushless DC motor, the present invention may be applied to a belt-driven starter/generator (BSG), or other equivalent devices. The present invention is available to a generator for vehicles as well because the engine compartment usually has a limited space. It must be pointed out that the embodiments described above are only some preferred embodiments of the present invention. All equivalent structures which employ the concepts disclosed in this specification and the appended claims should fall within the scope of the present invention.

What is claimed is:

1. A power driving device, which is electrically connected to a three-phase coil assembly having three coils, comprising:
three upper arm semiconductor switches, each of which has a first end and a second end, wherein the first ends of the upper arm semiconductor switches are electrically connected together, and the second ends thereof are electrically connected to the coils of the three-phase coil assembly respectively;
three lower arm semiconductor switches, each of which has a first end and a second end, wherein the second ends of the lower arm semiconductor switches are electrically connected together, and the first ends thereof are electrically connected to the second ends of the upper arm semiconductor switches respectively; and
three reverse breakdown diodes, each of which has an anode and a cathode, wherein the anodes of the reverse breakdown diodes are electrically connected to the second ends of the upper arm semiconductor switches respectively, and the cathodes thereof electrically connected to the first ends of the upper arm semiconductor switches respectively.

2. The power driving device of claim 1, further comprising three reverse breakdown diodes, each of which has an anode and a cathode, wherein the anodes of the reverse breakdown diodes are electrically connected to the second ends of the lower arm semiconductor switches respectively, and the cathodes thereof electrically connected to the first ends of the lower arm semiconductor switches respectively.

3. The power driving device of claim 1, wherein the reverse breakdown diodes are avalanche diodes.

4. The power driving device of claim 1, wherein the reverse breakdown diodes are transient voltage suppressor (TVS).

5. A DC motor, comprising:
a case;
a three-phase coil assembly, which has three coils, received in the case; and
a power driving device, which is received in the case, comprising;
three upper arm semiconductor switches, each of which has a first end and a second end, wherein the first ends of the upper arm semiconductor switches are electrically connected together, and the second ends thereof are electrically connected to the coils of the three-phase coil assembly respectively;
three lower arm semiconductor switches, each of which has a first end and a second end, wherein the second ends of the lower arm semiconductor switches are electrically connected together, and the first ends thereof are electrically connected to the second ends of the upper arm semiconductor switches respectively;
three reverse breakdown diodes, each of which has an anode and a cathode, wherein the anodes of the reverse breakdown diodes are electrically connected to the second ends of the upper arm semiconductor switches respectively, and the cathodes thereof electrically connected to the first ends of the upper arm semiconductor switches respectively; and
a controller electrically connected to the upper arm semiconductor switches and the lower arm semiconductor switches respectively to turn on and off the upper arm semiconductor switches and the lower arm semiconductor switches.

6. The DC motor of claim 5, wherein the power driving device further comprising three reverse breakdown diodes, each of which has an anode and a cathode; the anodes of the reverse breakdown diodes are electrically connected to the second ends of the lower arm semiconductor switches respectively, and the cathodes thereof electrically connected to the first ends of the lower arm semiconductor switches respectively.

7. The DC motor of claim 5, further comprising a shaft received in the case and having an end extending out of the case, wherein the power driving device further has a first substrate, on which the reverse breakdown diodes, the upper arm semiconductor switches, and the lower arm semiconductor switches are mounted; and the first substrate has a bore for the shaft passing through.

8. The DC motor of claim 7, wherein the controller has a second substrate and a control unit, both of which are electrically connected to the first substrate; the second substrate has a bore for the shaft passing through; and the control unit is mounted on the second substrate to turn on and off the upper arm semiconductor switches and the lower arm semiconductor switches.

9. The DC motor of claim 6, further comprising a shaft received in the case and having an end extending out of the case, wherein the power driving device further has a first substrate, on which the reverse breakdown diodes, the upper arm semiconductor switches, and the lower arm semiconductor switches are mounted; and the first substrate has a bore for the shaft passing through.

10. The DC motor of claim 9, wherein the controller has a second substrate and a control unit, both of which are electrically connected to the first substrate; the second substrate has a bore for the shaft passing through; and the control unit is mounted on the second substrate to turn on and off the upper arm semiconductor switches and the lower arm semiconductor switches.

11. The DC motor of claim 5, further comprising a power circuit and a ground circuit, wherein the power circuit has an end electrically connected to the first ends of the upper arm semiconductor switches and an opposite end extending out of the case; and the ground circuit has an end electrically connected to the second ends of the lower arm semiconductor switches and an opposite end extending out of the case.

12. The DC motor of claim 5, further comprising a control circuit having an end electrically connected to the controller and an opposite end extending out of the case.
